(19) United States
(12) Patent Application Publication
(10) Pub. No.: US 2006/0114518 A1
(43) Pub. Date: Jun. 1, 2006

(54) Photographic data conversion method and apparatus

(76) Inventor: Chao King, Fremont, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/001,740

(22) Filed: Dec. 1, 2004

(51) Int. Cl. H04N 1/23

(52) U.S. Cl. 358/302; 358/538

(57) ABSTRACT

The present application relates to a method and apparatus to convert various photographs from a photographic album to digital form.

### FIELD

The present invention relates to a method and apparatus for photographic data scanning and recording.

### INTRODUCTION

A photographic album that can include several photographs is very widely used for storing many photographs and is also sometimes used to view such photographs. However, photographic albums typically exhibit certain drawbacks. For example, it may be difficult for many users to find space for the storage of many photographic albums. Additionally, with multiple photographic albums in potentially different locations, users can encounter difficulties when they want to find a particular photograph that is stored in a photographic album. Recently, some users have attempted to rectify such problems by using a digital scanner to convert certain photographs included in the albums to digital form.

When used to scan pages of a photographic album, digital scanners typically convert an entire page of the photographic album, which may include several photographs. Thus, the scanned page typically contains an indivisible image of, e.g., several photographs. Therefore, if the user wants to divide the scanned page of the photographic album into several individual digital representations of each photograph included in the page, the user needs to additionally process the scanned page by, e.g., using various image processing software packages. This additional processing is typically a complicated procedure that can take a long time to implement. Accordingly, it is desirable to have a method and apparatus that overcomes one or more of these disadvantages.

### SUMMARY

According to various embodiments, the present teachings can provide a photographic data recording method that comprises the steps of scanning a page of a photographic album that comprises a plurality of photographs, producing a digital page image of the page of the photographic album, wherein the digital page image comprises a digital representation of the plurality of photographs, detecting a border of at least one of the plurality of photographs, extracting and producing a digital photograph image from the digital page image that substantially corresponds to the at least one of the plurality of photographs, producing an annotation corresponding to the digital photograph image, and recording the digital photograph image with the corresponding annotation.

According to various embodiments, the present teachings can provide a photographic data recording apparatus, comprising a scanning device that scans a page of a photographic album comprising a plurality of photographs, wherein the scanning device produces a digital page image of the page of the photographic album, an image processing device that detects a border of at least one of the plurality of photographs in the digital page image, wherein the image processing device extracts and produces a digital photograph image from the digital page image that substantially corresponds to the at least one of the plurality of photographs, an annotation device adapted to produce an annotation that corresponds to the digital photograph image, and a recording device adapted to record the digital photograph image with the annotation.

### BRIEF DESCRIPTION OF THE DRAWINGS

FIG. 1 illustrates a perspective view of a photographic data recording apparatus, according to certain embodiments;

FIG. 2 illustrates a block diagram of a photographic data recording apparatus, according to certain embodiments;

FIG. 3 illustrates a page of a photographic album including several photographs, according to certain embodiments; and

FIG. 4 illustrates a display of a photographic data recording apparatus, according to certain embodiments.

### DESCRIPTION OF CERTAIN EMBODIMENTS

In certain embodiments, a photographic data recording apparatus can comprise a scanning device, an image processing device, an annotation device and a recording device. The photographic data recording apparatus can scan a page of a photo album to create a digital representation of that page, process the digital representation, and record one or more digital photograph images.

In certain embodiments, the scanning device can be a device for digitally scanning a page of a photographic album. The page of the photographic album can include several photographs. The scanning device can produce a digital page image that can be a digital representation of the page of the photographic album. The scanning device can comprise a flat bed scanner. Flat bed scanners are known in the art, and can be obtained at most consumer electronics retailers. Typical sizes of flat bed scanners suitably used in certain embodiments of the invention include, but are not limited to, letter, A3, A4, or B4.

In certain embodiments, the image processing device can be a device that detects a border of at least one photograph included in the digital page image. The image processing device can extract and produce a digital photograph image of at least one photograph that is included in the digital page image. The image processing device can comprise an integrated circuit (“IC”) or a central processing unit (“CPU”) and, if necessary, can be combined with image processing software.

In certain embodiments, the annotation device can be a device for producing certain annotations that correspond to particular digital photograph images. The annotation device can comprise an IC or a CPU and, if necessary, can be combined with image processing software. Examples of annotations used in certain embodiments of the invention include, but are not limited to, information about the orientation of a photograph, the photograph's size, an ID tag corresponding to a particular photo, the date the photo was scanned, the date the photo was taken, and the like.

In certain embodiments, the recording device can be a device for recording a digital photograph image with annotations that correspond to that digital photograph image. Further, the recording device can record the digital page image that is produced by, e.g., the scanning device.

In certain embodiments, the recording device can record the digital photograph image with or without its corresponding annotation onto a removable image data recording medium. Examples of removable image data recording media include, but are not limited to, digital memory cards, compact discs (e.g., CD-R, CD-RW, etc.), and digital versatile discs (e.g., DVD-R, DVD-RW, DVD+RW, etc.). Various types of digital memory cards compatible with certain embodiments of the invention include, but are not limited to, secure digital (“SD”) memory cards, Compact Flash™, Smart Media™, Memory Stick™, and the like. Specific examples of recording devices that can be used include, but are not limited to, CD-R and/or a CD-RW writers, DVD-RW and/or a DVD+RW writers, and/or digital memory card recorders.

In certain embodiments, a digital photograph image can be recorded in a format that generally corresponds to the format of, e.g., a user's digital camera, viewer software, or CD/DVD player, to, e.g., facilitate a user's visualization of the photograph.

In certain embodiments, the photographic data recording apparatus can comprise a display device that can display a photographic image that generally corresponds to the digital photographic image produced by the image processing device. The display device can display one or more annotations along with each digital photographic image. If desired, the display device can display a display page image that generally corresponds to the digital page image produced by, e.g., the scanning device.

In certain embodiments, the display device can comprise a liquid crystal display (“LCD”), a Braun tube, a cathode ray tube (“CRT”), or a plasma display panel. In certain embodiments, the display device can comprise a touch panel as an input device for the input of, e.g., various instructions that facilitate the entrance and/or completion of a transaction. For example, a user can touch the touch panel to move and/or rotate one or more pictures. In another example, a user can sign his or her name to facilitate transfer of payment through the use of, e.g., a credit card. In certain embodiments, the input device can comprise a keyboard. The input device can be physically incorporated into the photographic data recording apparatus.

In certain embodiments, the photographic data recording apparatus can comprise a storage device that stores certain digital page images, certain digital photograph images, and/or certain corresponding annotations. In certain embodiments, the storage device can comprise a digital memory module, such as, for example, read only memory (“ROM”), random access memory (“RAM”), flash memory, or a hard disk. The storage device can store this information for a limited time. In certain embodiments, the storage device can store certain image processing programs that can facilitate the detection of the border of certain photographs, the extraction of the digital photograph images surrounded by such borders, and/or the provision of certain annotations.

In certain embodiments, the photographic data recording apparatus can incorporate all components (e.g., scanning device, image processing device, annotation device, recording device, display device, and the like) in one unit. However, the photographic data recording apparatus can be a system that comprises several separate units, such as, for example, a system that includes a flat bed scanner, a personal computer, a CD or DVD recorder, and a LCD display, which are all electronically connected to each other. The connections between various components can be through the use of wires and/or the components can connect wirelessly.

In certain embodiments, a method for recording photographic data can comprise the steps of scanning, producing, detecting, extracting, annotating, and recording. In certain embodiments, the method for recording photographic data can facilitate, e.g., conversion of a photographic album that contains a plurality of photographs into various digital images with corresponding annotations.

In certain embodiments, a method for recording photographic data can comprise a scanning step. In certain embodiments, the scanning step can facilitate the conversion of a page of a photographic album into digital form. In certain embodiments, the scanning step can lead to a producing step.

In certain embodiments, a method for recording photographic data can comprise a producing step wherein a scanning device can produce a digital page image that generally corresponds to the scanned photographic album page. Certain digital page images can be stored in the storage device temporarily. In certain embodiments, the producing step can lead to a detecting step.

In certain embodiments, a method for recording photographic data can comprise a detecting step wherein the digital page image can be analyzed by an image processing device. In certain embodiments, the image processing device can detect a border of one or more photographs that are included in the digital page image, as is described in further detail below. In certain embodiments, the detecting step can lead to an extracting step.

In certain embodiments, a method for recording photographic data can comprise an extracting step wherein the image processing device can extract a digital photograph image that generally corresponds to a photograph included in the digital page image. In certain embodiments, the extracting step can crop a photograph. For example, extraction can be restricted to a rectangular image even though the shape of the photograph is not rectangular. Other possible crops are possible including, but not limited to, circular, oval, star-shaped, etc. In certain embodiments, the extracting step can be conducted simultaneously with an annotation producing step. However, in certain embodiments, the annotation producing step can occur after the extracting step.

In certain embodiments, a method for recording photographic data can comprise an annotation producing step wherein certain annotations can be detected and/or input. For example, an annotation in the form of a photograph's orientation (e.g., vertical, horizontal, etc.) can be detected by comparing the horizontal length of the digital photographic image against the vertical height of the digital photographic image. In addition, a user can input certain annotations through the use of an input device such as, e.g., a keyboard. In certain embodiments, an annotation in the form of a photograph's size can be detected by and/or input into the annotation device. Examples of a photograph's size information include, but are not limited to, spatial information such as various lengths and widths (e.g., 8×10, 11×14, 16×20, panorama size, and the like).

Further examples of certain annotations include, but are not limited to, ID information or date information. In certain embodiments, ID information can be information that facilitates the identification of certain digital photograph images. Examples of ID information include, but are not limited to, numbers and/or titles that correspond to particular digital photograph images. Date information can be, e.g., information about the date when certain digital photographic images were scanned (scan date) or information about the date when certain photographs were taken (photograph date). In certain embodiments, various annotations such as, e.g., ID information and/or date information, can be input by an input device. The input device can be electronically connected to the photographic data recording apparatus.

In certain embodiments, the annotation device can append certain annotations to corresponding digital photograph images. For example, certain annotations can be added to a corresponding Exchangeable Image File Format (“EXIF”) portion of a digital photograph image.

In certain embodiments, the method for recording photographic data can comprise a confirming step by which a user can confirm the digital photograph image on the display device before proceeding to a recording step. In certain embodiments, a user can confirm various photographic attributes by providing an input in response to the information displayed on the display device. Examples of various photographic attributes include, but are not limited to, the digital photographic image itself, its border, its orientation, its size, and/or its ID information. If the user is not satisfied with the information displayed, the user can change one or more attributes corresponding to one or more photographs. The user can effectuate this change by providing an input to the input device.

In certain embodiments, a method for recording photographic data can comprise a recording step wherein certain digital photograph images can be recorded via the recording device to a removable image data recording medium. In certain embodiments, one or more digital photograph images can be recorded with corresponding annotations.

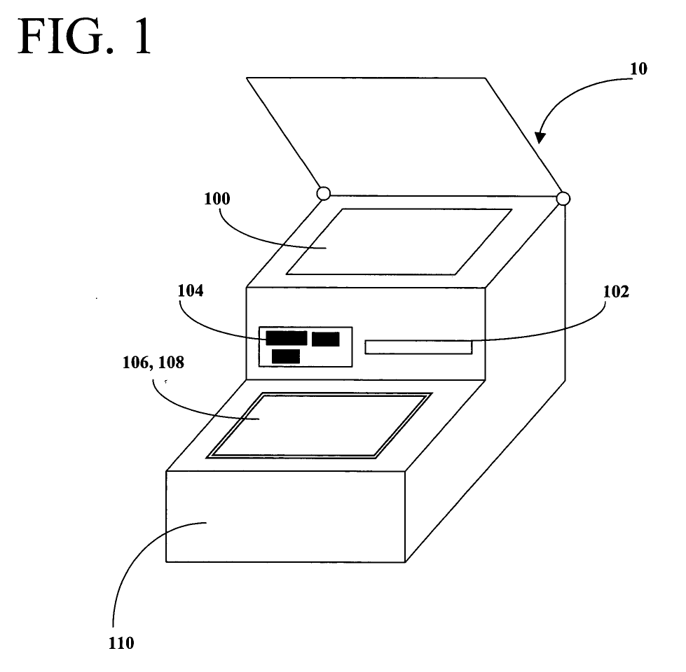

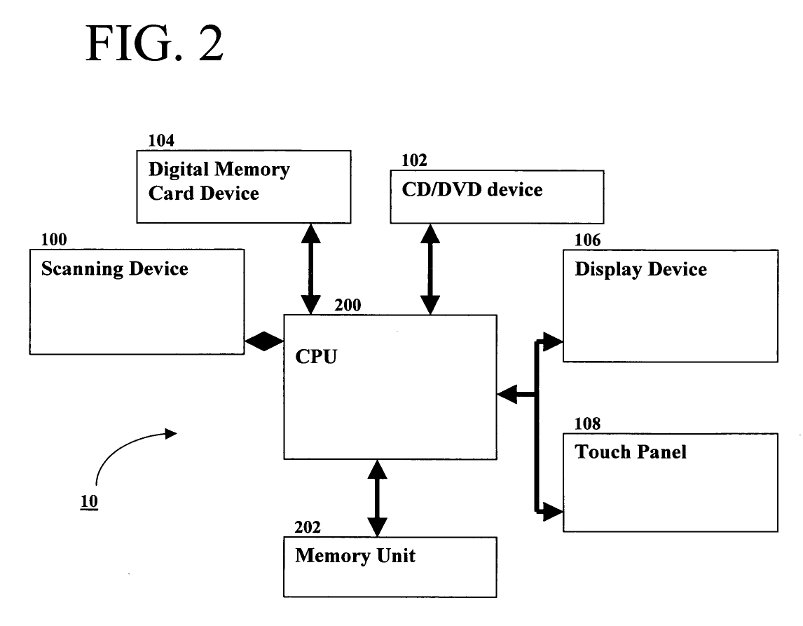

In certain embodiments, as illustrated in FIG. 1, a photographic data recording apparatus 10 can comprise a scanning device 100, a CD/DVD device 102, a digital memory card device 104, a display device 106, and a touch panel 108. In certain embodiments, scanning device 100, CD/DVD device 102, digital memory card device 104, display device 106, and touch panel 108 can be contained within body 110. In certain embodiments, as illustrated in FIG. 2, a CPU 200 and a memory unit 202 can also be included in body 110. In certain embodiments, CPU 200 can facilitate the operation and/or control of various components, including, but not limited to, CD/DVD device 102, digital memory card device 104, flat bed scanner 100, display device 106, touch panel 108, and/or memory 202.

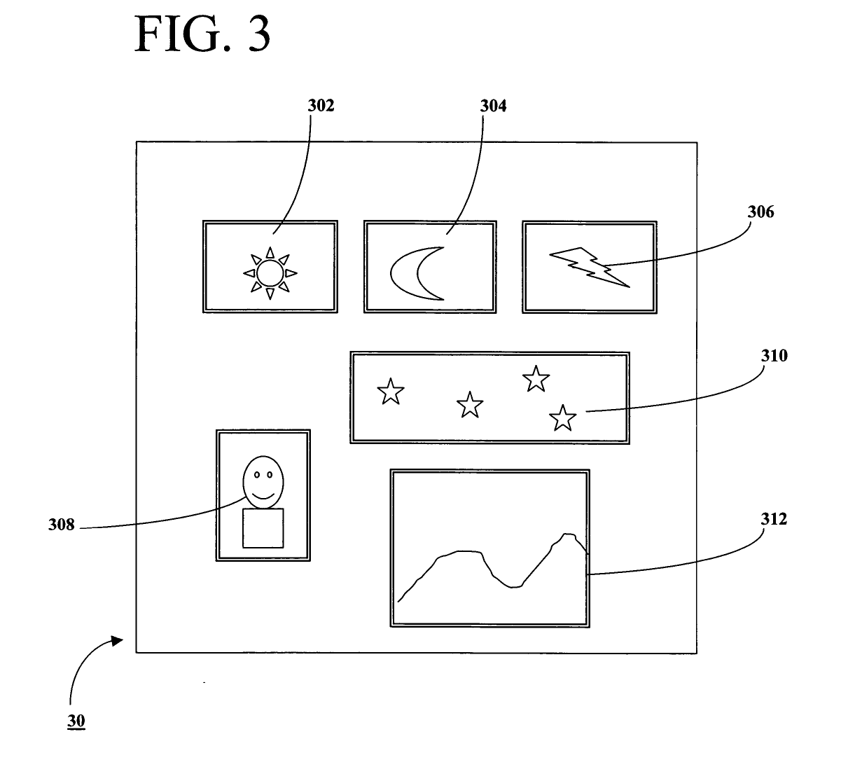

FIG. 3 illustrates certain embodiments of a photographic album page 30. Photographic album page 30 can comprise one or more photographs (e.g., 302, 304, and 306) that are horizontally oriented (i.e., a landscape orientation) and have a size of 8×10. In certain embodiments, photographic album page 30 can comprise one or more photographs (e.g., 308) that are vertically oriented (i.e., a portrait orientation) and have a size of 8×10. In certain embodiments, photographic album page 30 can comprise one or more photographs (e.g., 310) that exhibit a panoramic size. In certain embodiments, photographic album page 30 can comprise one or more photographs (e.g., 312) that have a size of 11×14. Although this exemplary embodiment recites two sizes, namely 8×10 and 11×14, any number of varying sizes can be utilized by certain embodiments of the invention.

In certain embodiments, photographic album page 30 can be scanned by scanning device 100 (e.g., a flat bed scanner). In certain embodiments, scanning device 100 can produce a digital page image of photographic album page 30. In certain embodiments, scanning device 100 can be sized to accommodate large photographic pages including, but not limited to, an A3-sized page. In certain embodiments, CPU 200 can note an annotation such as, e.g., the scanning date, and can store the annotation in a storage device such as, for example memory unit 202. In certain embodiments, the digital page image can be stored in memory unit 202 temporarily.

In certain embodiments, an image processing device (e.g., CPU 200 with certain image processing software) can detect one or more borders of one or more photographs (e.g., 302, 304, 306, 308, 310, 312) by analyzing the digital page image. For example, in certain embodiments, the image processing software can utilize various edge-detection algorithms that detect, e.g., a contrast differential in various directions. In addition, in certain embodiments, CPU 200 can calculate a photographic area based upon the borders it detects. One example of image processing software consistent with certain embodiments of the invention can be Adobe® Photoshop®, provided by Adobe® Systems, Inc.® of San Jose, Calif. In certain embodiments, image processing software can be stored in memory unit 202.

In certain embodiments, an image processing device (e.g., CPU 200 with optional image processing software stored in memory unit 202) can extract and produce from the digital page image one or more digital photograph images that are surrounded by borders. In certain embodiments, one or more digital photograph images can be temporarily stored in memory unit 202. The size of a digital photograph image representing one or more photographs can be adjusted. For example, large photograph 312 can be adjusted so that its size generally corresponds to the size of the display screen. A further example includes resizing a panorama photograph 310 to fit the display screen.

In certain embodiments, an annotation device such as, e.g., CPU 200, in combination with certain image processing software, can detect and extract one or more annotations (e.g., information regarding a photograph's orientation) by comparing the length of a horizontal border against the length of a vertical border. In addition, in certain embodiments, CPU 200 can detect and extract an annotation in the form of size information of certain digital photographic images by, e.g., measuring the length of each border. For example, the annotations corresponding to photographs 302, 304, and 306 can include a horizontal orientation, and a size of 8×10. In certain embodiments, an annotation representing ID information for one or more digital photograph images can be produced automatically by providing a sequential number. For example, ID information for photographs 302, 304, and 306 can be 001, 002, and 003, respectively. Certain annotation information such as, for example, the direction, size, date, and ID of one or more digital photograph images can be stored in memory unit 202. Examples of certain annotations according to certain embodiments of the invention are described in Table 1.

TABLE 1

| Photograph | Annotation Information | | | |
|---|---|---|---|---|
| (FIG. 2) | ID | Size | Orientation | Scanning Date |
| 302 | 001 | 8 × 10 | Horizontal | May 1, 2004 |
| 304 | 002 | 8 × 10 | Horizontal | May 1, 2004 |
| 306 | 003 | 8 × 10 | Horizontal | May 1, 2004 |
| 308 | 004 | 8 × 10 | Portrait | May 1, 2004 |
| 310 | 005 | Panorama | Horizontal | May 1, 2004 |
| 312 | 006 | 11 × 14 | Horizontal | May 1, 2004 |

In certain embodiments, one or more annotations can be appended to a digital photograph image by an annotation device (e.g., CPU 200) in combination with certain image processing software. For example, a digital photograph image of photograph 302 can be temporarily stored in memory unit 202 with one or more annotations, for example 001 as the ID annotation, 8×10 as the size annotation, horizontal as the orientation annotation, and May 1, 2004 as the scanning date annotation. In certain embodiments, all digital photograph images can be temporarily stored in memory unit 202 along with corresponding annotations.

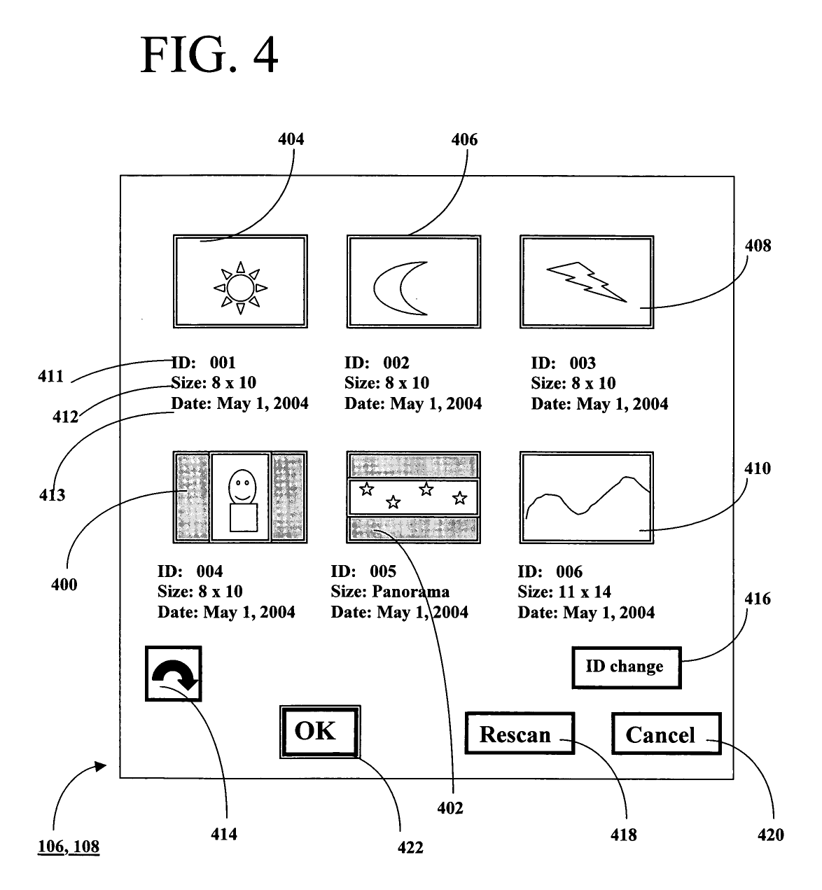

In certain embodiments, as illustrated in FIG. 4, display device 106 (e.g., an LCD display) can display one or more digital photograph images in an orientation that corresponds to the orientation annotation information. In this manner, the user can confirm these digital photograph images and their corresponding annotations before recording the digital photograph images onto a digital data recording medium. For example, a digital photograph image 400 is displayed in the portrait orientation according to the annotation orientation information associated with that image.

In certain embodiments, display device 106 can display one or more digital photograph images according to a predetermined parameter that generally indicates how many digital photograph images to display on display device 106 at one time. In certain embodiments, the predetermined parameter can be programmed into CPU 200 as a default parameter. In certain embodiments, the user can input the number of digital photograph images to be displayed on display device 106 at one time. In certain embodiments, depending in part upon the predetermined parameter, CPU 200 can calculate a predetermined size for each displayed image. In certain embodiments, as illustrated in FIG. 4, substantially all displayed images can each be contained within a uniform predetermined size. For example, referring to FIGS. 3 and 4, a panoramic picture 310 can be adjusted and displayed within the predetermined size in a panorama orientation 402.

In certain embodiments, one or more digital photograph images can be displayed on display device 106 so that each image is displayed substantially within the predetermined size. For example, as illustrated in FIG. 4, various digital photograph images in portrait orientation (e.g., 400) and/or panorama orientation (e.g., 402) can be displayed substantially within the predetermined size. In certain embodiments, various digital photograph images can be produced (e.g., 406, 408, 410) so that the size of the digital photograph images generally corresponds to the predetermined size. In certain embodiments, larger or smaller digital photograph images (e.g., 410) can be displayed at a size that generally corresponds to the predetermined size. In certain embodiments, various annotations such as, for example, ID annotation information 411, size annotation information 412, and/or scanning date annotation information 413, can be displayed below corresponding digital photograph images.

In certain embodiments, a user can change the orientation of one or more digital photograph images by touching an orientation change button 414 via an input device (e.g., touch panel 108) and thereafter touching the corresponding digital photograph image that the user desires to rotate. In certain embodiments, changed orientation annotation information can be stored as a new annotation in memory unit 202.

In certain embodiments, the user can change the ID annotation information of certain digital photograph images (e.g., 404) by touching an ID change button 416 via touch panel 108 and thereafter touching the corresponding photograph image (e.g., 404) whose annotation the user decides to amend. In certain embodiments, the user can input modified ID annotation information through the use of, e.g., a keyboard (not shown) and/or having touch panel 108 display a keyboard.

In certain embodiments, if the user is not satisfied with the result of the scanned image displayed on display device 106, the user can choose to repeat the scanning step by touching a Rescan button 418 via touch panel 108. In certain embodiments, the user can cancel certain operations by touching a Cancel button 420 via touch panel 108.

In certain embodiments, the user can proceed to the recording step by touching an OK button 422 via touch panel 108. In certain embodiments, when the user touches OK button 422, a prompting message such as, for example, “[P]lease insert your recording medium into this machine . . . ” can be displayed on display device 106.

In certain embodiments, the user can insert a removable image data recording medium such as, for example, a CD-R, CD-RW, DVD-RW, or DVD+RW, and the like, into a recording device (e.g., CD/DVD device 102, see, e.g., FIG. 1). In certain embodiments, the user can insert various digital memory cards, such as, for example, SD cards, SmartMedia™ cards, and the like, into a recording device (e.g., digital memory card device 104). In certain embodiments, various digital photograph images (e.g., 400, 402, 404, 406, 408, 410) can be recorded onto the removable image data recording media (e.g., CD-R, etc.) along with one or more annotations that correspond to those images. In certain embodiments, the digital page image that represents photographic album 30 can be recorded onto the removable image data recording medium (e.g., CD-R, etc.).

In certain embodiments, the user can view the various digital photographic images on the display device by using an appropriate player. For example, the user can use a DVD player to view various digital photographic images stored on a DVD. Similarly, in certain embodiments, the user can use a digital camera or a digital memory card reader to view one or more digital photographic images stored on a digital memory card.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A photographic data recording method, comprising:
scanning a page of a photographic album, the photographic album comprising a plurality of photographs;
producing a digital page image of the page of the photographic album, wherein the digital page image comprises a digital representation of the plurality of photographs;
detecting a border of at least one of the plurality of photographs on the digital page image;
extracting and producing a digital photograph image from the digital page image that is surrounded by the border and substantially corresponds to the at least one of the plurality of photographs;
producing an annotation corresponding to the digital photograph image; and
recording the digital photograph image with the annotation.

2. The photographic data recording method of claim 1, wherein the annotation comprises orientation information that corresponds to the orientation of at least one of the plurality of photographs, and
wherein the digital photograph image is displayed on a display device in a manner that generally corresponds to the orientation information.

3. The photographic data recording method of claim 1, wherein the annotation comprises ID information that identifies one or more identification characteristics about the at least one of the plurality of photographs.

4. The photographic data recording method of claim 3, wherein the one or more identification characteristics are selected from the following: photograph size, ID number, scan date, photograph date, batch number, and photograph orientation.

5. The photographic data recording method of claim 1, wherein the digital photograph image is recorded onto a removable image data recording medium.

6. The photographic data recording method of claim 5, wherein the removable image data recording medium comprises a CD, a DVD, or a CD and a DVD.

7. A photographic data recording apparatus, comprising:
a scanning device that scans a page of a photographic album, the photographic album comprising a plurality of photographs, wherein the scanning device produces a digital page image of the page of the photographic album,
an image processing device that detects a border of at least one of the plurality of photographs on the digital page image, wherein the image processing device extracts and produces a digital photograph image from the digital page image that is surrounded by the border and substantially corresponds to the at least one of the plurality of photographs,
an annotation device adapted to produce an annotation that corresponds to the digital photograph image, and
a recording device adapted to record the digital photograph image with the annotation.

8. A computer readable medium that, when executed by a processor, performs the steps of:
receiving a digital page image of a page of a photographic album, wherein the photographic album comprises a plurality of photographs and wherein the digital page image comprises a digital representation of the plurality of photographs;
detecting a border of at least one of the plurality of photographs;
extracting and producing a digital photograph image that substantially corresponds to the at least one of the plurality of photographs;
producing an annotation corresponding to the digital photograph image; and
recording the digital photograph image with the annotation.

9. A computer readable software distributed on a computer network that, when executed by a processor, performs the steps of:
receiving a digital page image of a page of a photographic album, wherein the photographic album comprises a plurality of photographs and wherein the digital page image comprises a digital representation of the plurality of photographs;
detecting a border of at least one of the plurality of photographs;
extracting and producing a digital photograph image that substantially corresponds to the at least one of the plurality of photographs;
producing an annotation corresponding to the digital photograph image; and
recording the digital photograph image with the annotation.

10. A computing system that includes a processor and a memory, the processor executing steps in the memory that performs the steps of:
scanning a page of a photographic album, the photographic album comprising a plurality of photographs;
producing a digital page image of the page of the photographic album, wherein the digital page image comprises a digital representation of the plurality of photographs;
detecting a border of at least one of the plurality of photographs;
extracting and producing a digital photograph image that substantially corresponds to the at least one of the plurality of photographs;
producing an annotation corresponding to the digital photograph image; and
recording the digital photograph image with the annotation.
